(19) United States
(12) Patent Application Publication
(10) Pub. No.: US 2011/0270585 A1
(43) Pub. Date: Nov. 3, 2011

(54) COLLIMATION LENS HAVING FREEFORM SURFACE AND DESIGN METHOD THEREOF

(76) Inventors: JIN-JIA CHEN, Taichung City (TW); Chin-Tang Lin, Zhonghe City (TW)

(21) Appl. No.: 12/876,171

(22) Filed: Sep. 6, 2010

(30) Foreign Application Priority Data
Apr. 29, 2010 (TW) 099113724

(51) Int. Cl. G06F 17/50; G02B 27/30

(52) U.S. Cl. 703/1; 359/641

(57) ABSTRACT

A freeform surface included collimation lens is provided, which is designed through a freeform surface design process to provide an integrally-formed unitary structure. The design method includes a step of identifying an optic field pattern of light source, a step of performing graphic analysis of freeform surface tangential vector formula, a step of acquiring freeform surface control point, a step of constructing a three-dimensional model, and a step of performing geometric processing. Through these steps, tangential vectors of control points of each freeform surface are determined and an approximating process or an exact solution process is adopted to determine the coordinates of the points of the freeform surface. Three-dimensional modeling software is then employing to construct an ellipsoid collimation lens, which realizes an optic collimation performance of at least 88% when tested with a circular disk set at a distance of 200 meters and having a diameter of 35 meters.

### TECHNICAL FIELD OF THE INVENTION

The present invention generally relates to the field of design of LED (Light-Emitting Diode) optical collimation lens, and more particularly to the design of integrally-formed collimation lens by adopting freeform surface method in order to shorten the time needed for assembling and adjusting lenses, improve collimation performance, and substantially reduce the amount of space occupied.

### DESCRIPTION OF THE PRIOR ART

Techniques associated with light-emitting diodes (LED) have been recently under fast development and progress. The LEDs, which were only used for indication purposes, are increasingly replacing various light sources to play an important role as light sources for various lighting systems. Literatures that discuss the applications of LED in various lighting system, such as backlighting, head and ail lights of automobiles, homogeneous lighting systems, and street lighting, are easily available. The LED, which possesses various advantages, including high lighting efficiency, less consumption of power, long lifespan, small volume, and being environmentally friendly, is also advantageous in that, as compared to the traditional light sources, the LED shows unique lighting characteristics for the LED has a radiation pattern that shows directionality and is thus totally different from the traditional light sources. Consequently, the LED is not fit for applications in regular optical structures or optic assemblies; rather it is more suitable for optic arrangements in respect of collimated light sources.

An optic collimation lens is of very wide application in various fields. In respect of lighting, the characteristics of collimation can be used for design of an extra long range search light or rescue light, or alternatively, it can be used with an infrared light source to provide a light source for long range nighttime monitoring or photographing and recording. In respect of optic coupling, the LED or other light sources that have great light emission angles can be coupled to a light pipe or other optic structures that have small apertures or diameters.

Considering a simple mathematic function for a conventional way of optic design and a design process adopting optic freeform surface, as shown in FIG. 1, “x” represents the optic field pattern of a light source, “y” is the optic field pattern of the light received in a receiving site, and “f” is the function of the optic structure or optic system to be designed between the light source and the receiving site. With such a representation, the optic system can be shown as y=f(x). In the conventional way of design, a desired optic field pattern is obtained by combining known optic elements or optic surfaces and thus, in the process of design, the optic field pattern of the light source and the optic system are known parameters, but the optic field pattern that is projected from the optic system is an unknown parameter.

For a known design process of collimation lens, the design is carried out on the basis of certain lenses that have regular curved surfaces, such as plane, sphere, ellipsoid, paraboloid, hyperboloid, and cylinder, and the design is done through combination of these known types of lenses. FIGS. 2 and 3 show conventional optic collimation lenses. FIG. 2 provides a collimation lens system that is composed of three optic lenses, while that of FIG. 3 is composed of four optic lenses. However, the geometric characteristics of these regular curved surfaces are simple and are of certain limitations, so that in performing designs, several different curved surfaces must be simultaneously used, and further subjected to proper assembling and adjustment, in order to realize the desired optic property. Such an adjustment process is usually a trial-and-error process, which requires repeated trials and numerous corrections to be done before a satisfactory optic structure is obtained. This is time consuming and is not economic. Further, an optic structure designed in this way is poor in both optic performance and precision.

From the above explanation, it can be appreciated that the conventional collimation lens systems are often composed of multiple optic lenses. This increases the costs and requires light beam to be subjected to multiple times of refraction before it exits the lens system. In view of such a physical constraint, each lens of the lens system must be precisely positioned; otherwise the collimation performance will be greatly affected. Incorrect positioning of any one of the lenses of the lens system will lead to the performance of collimation. The conventional collimation lens also suffers another drawback that the lens system only works for collimating light coming in a given angular range. As shown in the drawings, lights coming from sites above and under the light source are not allowed to enter the lens structure. Due to such a reason, the conventional collimation lens systems are only good for light sources of small divergence angles; and the optic performance of the conventional collimation lens systems will become poor when they are applied to LED light sources that have great divergence angles.

Due to the above discussed drawbacks of the conventional collimation lens and also due to the unsuitability of the conventional collimation lens for the LED light sources that have great divergence angles, it is desired to provide a freeform surface included, integrally-formed unitary collimation lens in order to eliminate the trouble of precisely positioning lenses in a lens structure or lens system, effectively reduce the amount of space occupied and shorten the overall length, and also to expand the range of receiving light to cover substantially half a sphere, thereby making it applicable to an LED light source that possesses a great divergence angle and also enhancing the practicability and function of a collimation lens. This effectively overcomes the problems of the known collimation lens system that requires a combination of multiple lenses and often shows poor collimation performance and occupies a great amount of space.

### SUMMARY OF THE INVENTION

Thus, the primary objective of the present invention is to provide a design method of a freeform surface included collimation lens, which is constructed as a collimation lens having one or more freeform surfaces to effectively improve collimation performance.

Further, another objective of the present invention is to provide a freeform surface included collimation lens that comprises an integrally-formed unitary structure so as to reduce the amount of space for assembling and eliminate the need for alignment and calibration of lenses thereby providing the efficacies of being easy to assemble and showing improved collimation performance.

To achieve the above objectives, the present invention adopts the following technical solution, which provides a design method of a collimation lens to be presented between an optic field pattern of a light source and a desired optic field pattern of a receiving surface, which are both considered known parameters for the design. The design method comprises a step of identifying an optic field pattern of light source, a step of performing graphic analysis of freeform surface tangential vector formula, a step of acquiring freeform surface control point, a step of constructing a three-dimensional model, and a step of performing geometric processing.

Firstly, the step of identifying an optic field pattern of light source is performed, in which modeling parameters, including luminous intensity distribution, light emission area, aperture, and location, of a light source to be used are identified and further, modeling parameters of a desired destination optic field pattern including maximum projection brightness, projection illumination, projection distance, and projection area of light projected from the light source are determined for a receiving surface.

Then, the step of performing graphic analysis of freeform surface tangential vector formula is carried out for handling, in a design process of collimation lens, the following issues: (A) a spot light source being reflected by a freeform surface to converge at a point; (B) a spot light source being refracted by a freeform surface to travel in parallel to an optic axis for outward emission; and (C) a spot light source being refracted by a freeform surface to converge at a point.

Afterwards, the step of acquiring freeform surface control point is performed, in which either the approximating process or the exact solution process is adopted for computation of coordinates of control points required for construction of a freeform surface.

Then, the step of constructing a three-dimensional model is performed, wherein the light source identified in the step of identifying optic field pattern of light source is used as an input parameter and the optic field pattern desired for the receiving surface identified in the step of identifying optic field pattern of light source is used as an output parameter, and followed by applying the step of acquiring freeform surface control points to determine the coordinates of points of the whole freeform surface, and then supplying the coordinates of the points so determined to three-dimensional modeling software to construct two-dimensional freeform curves.

Finally, the step of performing geometric processing is carried out to complete all the two-dimensional curves and to make a rotation of 360 degrees about the optic axis by which the structure of the collimation lens is done.

The freeform surface included collimation lens so constructed comprises an integrally-formed unitary ellipsoid structure. The collimation lens comprises five interconnecting optic surfaces on each side of an optic axis, and these optic surfaces include a spherical surface, a reflection surface, a refracting-parallel surface, a refracting-converging surface, and a converging-refracting-parallel surface. Except the spherical surface, all the remaining four surfaces are freeform surfaces obtained through a freeform surface design process.

The spherical surface is a concave spherical surface, functioning to allow light from a light source to directly enter the collimation lens without undesired deflection.

The reflection surface is a freeform surface obtained through an approximating process and functions to re-direct light from the light source to converge in a direction toward a converging point. The position of a starting point of the reflection surface determines the aperture of the collimation lens, and an end of the surface intersects the spherical surface on a vertical axis of the light source.

The refracting-parallel surface is a freeform surface that is obtained through an exact solution process. The light distribution of the collimation lens is divided into three zones because a minor portion of the light from the light source cannot reach the converging-refracting-parallel surface after being re-directed by the reflection surface, so that a portion of the reflection surface is modified to form the refracting-parallel surface, which is connected to an end of the reflection surface opposite to the spherical surface, whereby light impinging on the refracting-parallel surface is refracted to a direction parallel to the optic axis for exiting the collimation lens

The refracting-converging surface is a freeform surface that is obtained through an approximating process and functions for refracting a portion of light from the light source that is close to the optic axis to converge in a direction toward the converging point. The refracting-converging surface is connected to an end of the spherical surface that is opposite to the reflection surface.

The converging-refracting-parallel surface is a freeform surface obtained through an exact solution process and functions to refract the portion of light that is subjected to reflection and/or refraction by the reflection surface and/or the refracting-converging surface at the time when the portion of the light reaches the converging-refracting-parallel surface so that the light travel parallel to the optic axis for exiting the collimation lens.

As such, through practice of the above discussed technical solution according to the present invention, a collimation lens that is constructed according to the present invention is applicable to an LED based light source and overcome the drawbacks of wasting space and poor collimation performance found in the conventional collimation lens systems that are often composed of multiple lenses. Since the freeform surface included collimation lens according to the present invention is made as an integrally-formed unitary structure, it eliminates the trouble of positioning lenses and effectively reduces the amount of space occupied and shortens the overall length, and thus improves the practicability of and performance of collimation lens.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing an arrangement of light source and received optic field pattern for optic design of a conventional collimation lens.

FIG. 2 is a sectional view of a conventional optic collimation lens.

FIG. 3 is a sectional view of another conventional optic collimation lens.

FIG. 4 is a schematic view showing an arrangement of light source and received optic field pattern for freeform surface design method according to the present invention.

FIG. 5 is a perspective view showing a freeform surface included collimation lens according to the present invention.

FIG. 6 is planar representation of the freeform surface included collimation lens according to the present invention.

FIG. 7 is a schematic two-dimensional representation of the freeform surface included collimation lens according to the present invention.

FIG. 8 is a geometric analysis plot for light being reflected to travel in parallel for the freeform surface included collimation lens according to the present invention.

FIG. 9 is a geometric analysis plot for light reflected to converge at a point for the freeform surface included collimation lens according to the present invention.

FIG. 10 is a geometric analysis plot for light refracted to travel in parallel for the freeform surface included collimation lens according to the present invention.

FIG. 11 is a geometric analysis plot for light refracted to converge at a point for the freeform surface included collimation lens according to the present invention.

FIG. 12 shows graphic analysis of acquirement of control points through an approximating process for the freeform surface included collimation lens according to the present invention.

FIG. 13 is flow chart illustrating acquirement of control points through the approximating process for the freeform surface included collimation lens according to the present invention.

FIG. 14 shows graphic analysis of acquirement of control points through an exact solution process for the freeform surface included collimation lens according to the present invention.

FIG. 15 is flow chart illustrating acquirement of control points through the exact solution process for the freeform surface included collimation lens according to the present invention.

FIG. 16 illustrates generation of freeform curves for the design of the freeform surface included collimation lens according to the present invention.

FIG. 17 illustrating addition of circular arc for the design of the freeform surface included collimation lens according to the present invention.

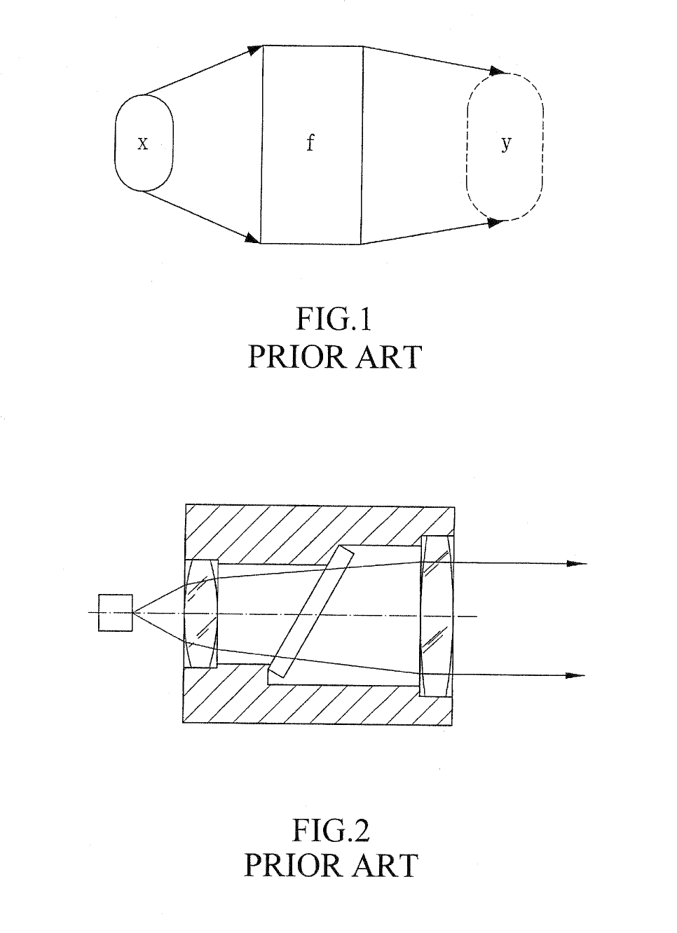

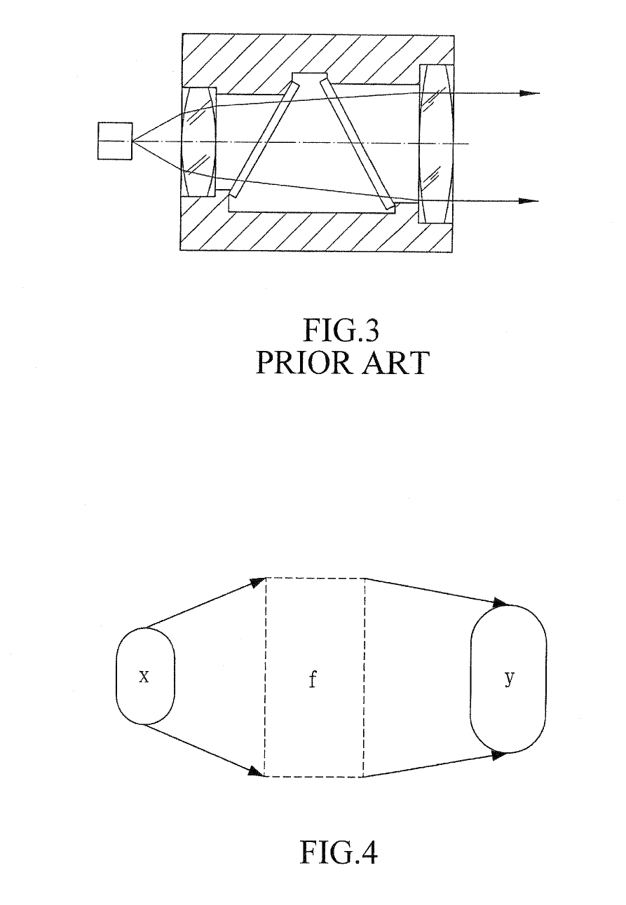

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIG. 4, a description will be given, in which “x” indicates an optic field pattern of a light source, “y” indicates an optic field pattern of a receiving surface, and “f” is a function of the optic structure to be designed according to the present invention, whereby the optic system is represented by the formula y=f(x). According to the present invention, an optic structure of a collimation lens is designed with a freeform surface method and thus, known parameters of the design method are the optic field patterns “x” and “y” of the light source and the receiving surface, while the unknown parameter is the optic structure “f”.

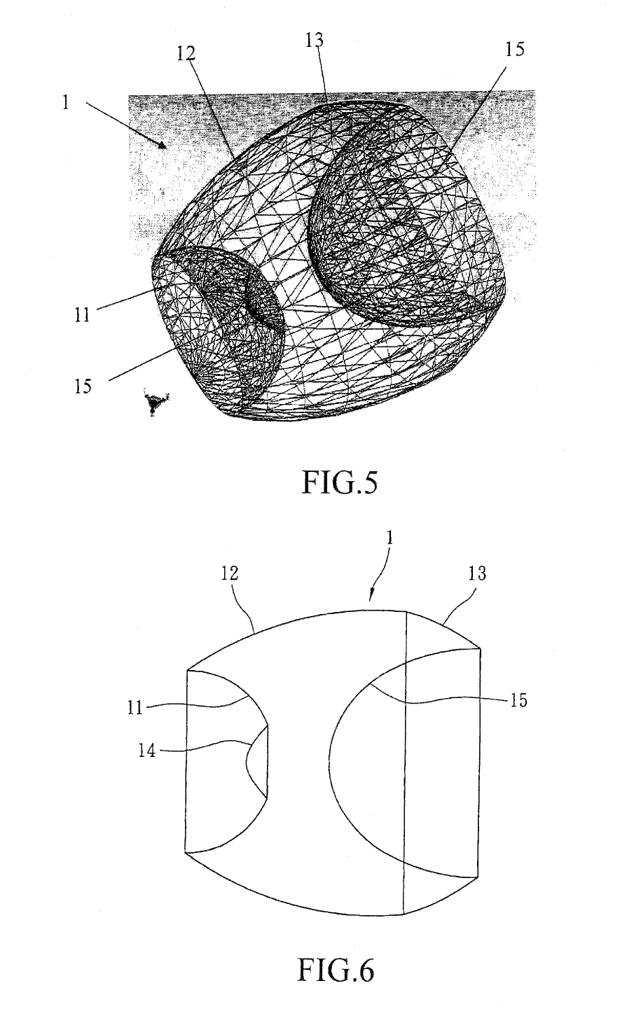

As shown in FIGS. 5-7, the collimation lens according to the present invention is an integrally-formed unitary ellipsoid structure, in which the collimation lens, generally designated at 1, comprises five interconnecting optic surfaces on each side of an optic axis 10, which are respectively designated as “spherical surface 11”, “reflection surface 12”, “refracting-parallel surface 13”, “refracting-converging surface 14”, and “converging-refracting-parallel surface 15”. Except the spherical surface 11, all the remaining four surfaces are freeform surfaces obtained through the freeform surface design method. The freeform surface design method can be performed either with an approximating process or an exact solution process.

The spherical surface 11 is a concave spherical surface, providing a function to allow light from a light source to directly enter the collimation lens 1 without undesired deflection.

The reflection surface 12 is a freeform surface obtained with computation performed by an approximating process and provides a function to re-direct the light from the light source to converge in a direction toward a converging point. The position of a starting point of the reflection surface 12 affects the size of the reflection surface 12 and also determines the aperture or diameter of the collimation lens 1 and has an end intersecting the spherical surface 11 on a vertical axis of the light source.

The refracting-parallel surface 13 is a freeform surface that is obtained through an exact solution process. Light distribution of the collimation lens 1 is divided into three zones and this is because a minor portion of the light from the light source cannot reach the converging-refracting-parallel surface 15 after being re-directed by the reflection surface 12, so that a portion of the reflection surface 12 is modified to form the refracting-parallel surface 13, which is connected to the end of the reflection surface 12 opposite to the spherical surface 11, whereby light impinging on the refracting-parallel surface 13 is refracted to a direction parallel to the optic axis 10 for exiting the collimation lens 1.

The refracting-converging surface 14 is a freeform surface that is obtained through an approximating process and provides a function for refraction of a portion of the light from the light source that is close to the optic axis 10 to converge in a direction toward the converging point. The position of a starting point of the refracting-converging surface 14 is set on the optic axis 10 and the refracting-converging surface 14 is connected to an end of the spherical surface 11 that is opposite to the reflection surface 12 to enhance the coverage of light angle of the light source and to improve the collimation performance of light.

The converging-refracting-parallel surface 15 is a freeform surface obtained through an exact solution process and functions to refract the portion of light that is subjected to reflection and/or refraction by the reflection surface 12 and/or the refracting-converging surface 14 at the time when the portion of the light reaches the converging-refracting-parallel surface 15 so that the light travel parallel to the optic axis 10 for exiting the collimation lens 1.

As such, a freeform surface included collimation lens showing high collimation performance and having an integrally-formed unitary ellipsoid structure is realized.

The design method of the freeform surface included collimation lens 1 that is applicable to an LED (Light-Emitting Diode) light source comprises a step of identifying an optic field pattern of a light source, a step of performing graphic analysis of freeform surface tangential vector formula, a step of acquiring freeform surface control point, a step of constructing a three-dimensional model, and a step of performing geometric processing.

Firstly, the step of identifying an optic field pattern of light source is performed, in which modeling parameters, including luminous intensity distribution, light emission area, aperture, and location, of an LED chip used as a light source are identified and further, modeling parameters of a desired destination optic field pattern, including maximum projection brightness, projection illumination, projection distance, and projection area of light projected from the light source, are determined for a receiving surface.

Then, the step of performing graphic analysis of freeform surface tangential vector formula is carried out. Taking the ellipsoid collimation lens 1 to be manufactured according to the present invention, each side of the optic axis 10 comprises fives interconnected optic surfaces, which are respectively the spherical surface 11 and the refracting-converging surface 14 both opposing the light source, the reflection surface 12 that forms a circumferential surface, and the refracting-parallel surface 13 and the converging-refracting-parallel surface 15 both re-directing light to travel in parallel to projection field pattern. Geometric problems associated with theses optic surfaces are analyzed in this step, including:

(A) A spot light source is reflected by a freeform surface to converge at a point;

(B) A spot light source is refracted by a freeform surface to travel in parallel to an optic axis for outward emission; and

(C) A spot light source is refracted by a freeform surface to converge at a point.

According to the present invention, a freeform surface is constructed with the aid of three-dimensional modeling software, so that all control points of the freeform surface must be determined first through proper computation. According to the present invention, the control points are determined through computation performed with either the approximating process or the exact solution process mentioned above. Both processes require calculation that uses tangential vector. Thus, optic geometry analysis and calculation of tangential vectors of optic surface for each light beam are preliminary work for construction of a freeform surface.

For the above listed three problems, they are analyzed based on the assumption of the light source of the collimation lens 1 being an ideal spot light source and energy distribution of light is not taken into consideration here with the only concern being put on collimation of light. Before the analysis of the above listed geometric problems is performed, it is desired to understand the principle of reflection for a spot light source being reflected by a freeform surface to travel in parallel to an optic axis 10.

FIG. 8 shows a geometric analysis plot for light being reflected to travel in parallel. Under the assumption that a light source, indicated by “O”, is an ideal spot light source and “P” is an arbitrary point of a reflection surface, an light ray incident onto point P forms an included angle “i” with respect to the horizontal axis. Parameters θ₁ and θ₂ respectively indicate incidence angle and reflection angle of the light ray. The symbol T_{P} indicates a tangential vector of point P and T_{P} forms an included angle β with respect to the horizontal axis. Geometry of the light ray shows the following two equations:

$$\begin{matrix}{θ}_{1} - i + {θ}_{2} = \frac{π}{2} & ( 1.1 ) \\ β = \frac{π}{2} - {θ}_{1} + i & ( 1.2 )\end{matrix}$$

The optic nature of point P is reflection and the principle of reflection tells that the incidence angle θ₁ and the reflection angle θ₂ are identical. Re-arrangement of equations (1.1) and (1.2) provides answers for the incidence angle θ₁, the reflection angle θ₂, and the angle β as follows:

$$\begin{matrix}{θ}_{1} = {θ}_{2} = \frac{π}{4} + \frac{i}{2} & ( 1.3 ) \\ β = \frac{π}{4} + \frac{i}{2} & ( 1.4 )\end{matrix}$$

It is noted in equation (1.3) that when angle i is zero degree, the angles of θ₁ and θ₂ have a lower bond of p/4. Since the present invention provides a design for lens, which is made of acrylic, the critic angle is around 42.05 degrees. When light impinges on the reflection surface that is located on an outside face of the lens, all light rays have an incidence angle greater than the critic angle, meaning total reflection occurs for light ray directly impinging on the reflection surface. Reflectivity is high for light reflected through total reflection so that there is no need to provide a coating of high reflective index material on the outside surface of the lens for improving light reflectivity.

In the construction of the freeform surface, the light incidence angle i is a known variable and equation (1.4) can determine the included angle β between a tangential line of an arbitrary point P of the surface and X-axis. The tangential vector TP is formulated as follows:

T_{P}=[−1, tan β] (1.5)

Combining equation (1.4) with equation (1.5) shows:

$${T}_{P} = [ - 1 , tan ( \frac{π}{4} + \frac{i}{2} ) ] \qquad ( 1.6 )$$

With equation (1.6), the vector components of each point of the freeform surface can be calculated. Afterwards, the approximating process or exact solution process mentioned above can be applied, in the form of computer program, to carry out repeated computations for acquiring the coordinates of all control points with which a freeform curve can be plotted.

Then, analysis of the above mentioned geometric problems will be discussed.

(A) spot light source is reflected by a freeform surface to converge at a point (namely the formation of the reflection surface of the ellipsoid collimation lens):

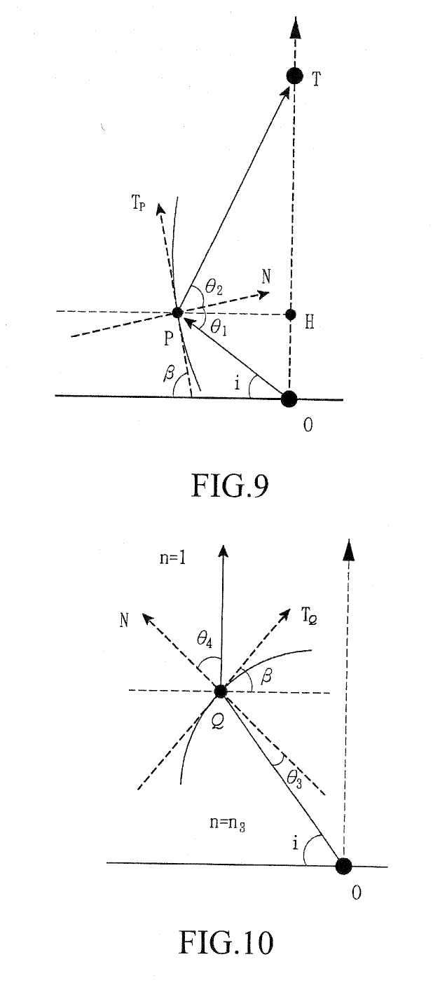

FIG. 9 shows a geometric analysis plot for light reflected to converge at a point. Under the assumption that the light source O is an ideal spot light source and P is an arbitrary point of the reflection surface, angle i is an included angle between a light ray incident onto point P and the horizontal axis, symbols θ₁ and θ₂ are respectively incidence angle and reflection angle of the light ray, T_{P} is a tangential vector of point P, and angle β is an included angle between T_{P} and the horizontal axis, the coordinates of point T is the location where the light is to converge after being reflected. Point H is a vertical projection of point P on the optic axis 10.

The included angle between a reflected light ray and the horizontal axis changes with the location of point P. In other words, the location of point P must be determined first before the direction of a reflected light ray can be identified and the tangential vector T_{P} of point P can be calculated. Since the computation sequence of this process is inconsistent to the computation process of the exact solution process, this geometric problem can only be handled with the approximating process to determine the location of the control point.

According to the computation process of the approximating process, during the computation of each light ray, the coordinates of point P are considered known parameters. For example, the coordinates of point P for the first light ray are the coordinates of the initial point P₀. The geometric relationship of FIG. 9 provides the following equation:

$$\begin{matrix}{θ}_{1} + {θ}_{2} = ∠ TPH + i & ( 1.7 ) \\ β = \frac{π}{2} - {θ}_{1} + i & ( 1.8 )\end{matrix}$$

Since the coordinates of points T, P, and H are known, the angle ∠TPH is defined as:

$$∠ TPH = {tan}^{- 1} ( \frac{\overline{TH}}{\overline{PH}} ) \qquad ( 1.9 )$$

According to the principle of reflection, the incidence angle θ₁ and the reflection angle θ₂ are identical. Re-arrangement of equations (1.7), (1.8), and (1.9) provides an answer for angle β as follows:

$$β = \frac{π}{2} - \frac{1}{2} {tan}^{- 1} ( \frac{\overline{TH}}{\overline{PH}} ) + \frac{i}{2} \qquad ( 1.10 )$$

The tangential vector T_{P} of point P is expressed as equation (1.5) and combining equation (1.10) with equation (1.5) obtains:

$${T}_{P} = [ - 1 , tan ( \frac{π}{2} - \frac{1}{2} {tan}^{- 1} ( \frac{\overline{TH}}{\overline{PH}} ) + \frac{i}{2} ) ] \qquad ( 1.11 )$$

With the calculation of the tangential vector for each point properly done, the approximating process mentioned above can be applied for computation of the coordinates of all the control points, which are supplied to the three-dimensional modeling software to plot the desired freeform curve, namely the reflection surface 12 of the ellipsoid collimation lens 1.

(B) A spot light source is refracted by a freeform surface to travel in parallel to an optic axis 10 for outward emission (namely the formation of the refracting-parallel surface and the converging-refracting-parallel surface of the ellipsoid collimation lens)

FIG. 10 shows a geometric analysis plot for light refracted to travel in parallel. Again, the following assumptions are made. The light source O is an ideal spot light source and Q is an arbitrary point of the refraction surface; angle i is an included angle between a light ray incident onto point Q and the horizontal axis; symbols θ₃ and θ₄ are respectively incidence angle and refraction angle of the light ray; T_{Q} is a tangential vector of point Q; and angle β is an included angle between T_{Q} and a horizontal line.

According to the geometric relationship of FIG. 10, the following equations among θ₃, θ₄, and β can be obtained:

$$\begin{matrix}i - {θ}_{1} + {θ}_{2} = \frac{π}{2} & ( 1.12 ) \\ β = \frac{π}{2} - i + {θ}_{3} & ( 1.13 )\end{matrix}$$

Since θ₃ and θ₄ are incidence angle and refraction angle, the principle of refraction indicates the following equation:

n₃ sin θ₃=sin θ₄ (1.14)

Solving equations (1.12) and (1.14) simultaneously provides the following solution:

$${θ}_{3} = {tan}^{- 1} ( \frac{cos i}{{n}_{3} - sin i} ) \qquad ( 1.15 )$$

Combining equation (1.15) with equation (1.13) provides the angle β as follows:

$$β = \frac{π}{2} - i + {tan}^{- 1} ( \frac{cos i}{{n}_{3} - sin i} ) \qquad ( 1.16 )$$

The tangential vector T_{Q} of point Q is:

T_{Q}=[1, tan β] (1.17)

Putting the solution of β of equation (1.16) into equation (1.17) provides the relationship between the tangential vector T_{Q} and the angle i as follows:

$${T}_{Q} = [ 1 , tan ( \frac{π}{2} - i + {tan}^{- 1} ( \frac{cos i}{{n}_{3} - sin i} ) ) ] \qquad ( 1.18 )$$

Equation (1.18) indicates that the tangential vector T_{Q} is a function of i, and is not related to the coordinates of point Q on the refraction surface. In other words, there is no need to first obtain the coordinates of point Q before the computation of the tangential vector T_{Q} is to be performed. Consequently, this geometric problem is fit to the exact solution process. After the control point of the freeform surface is determined through the exact solution process, a desired freeform curve can be plotted, namely the refracting-parallel surface 13 or the converging-refracting-parallel surface 15 of the ellipsoid collimation lens 1 can be formed.

(C) A spot light source is refracted by a freeform surface to converge at a point (namely the formation of the refracting-converging surface of the ellipsoid collimation lens)

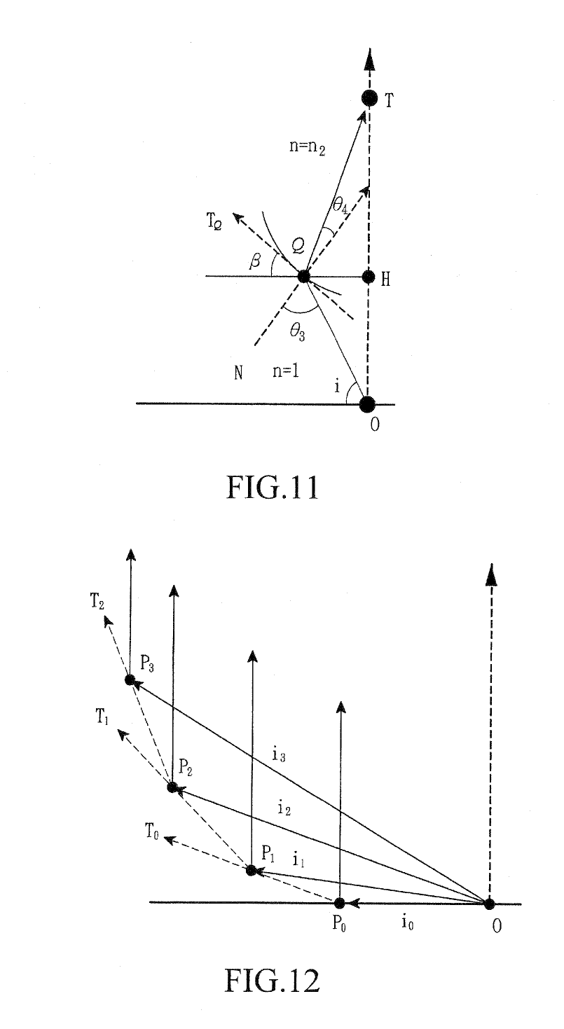

FIG. 11 shows a geometric analysis plot for light entering from air into acrylic material to converge at a point. Again, the following assumptions are made. The light source O is an ideal spot light source and Q is an arbitrary point of the refraction surface; angle i is an included angle between a light ray incident onto point Q and the horizontal axis; symbols θ₃ and θ₄ are respectively incidence angle and refraction angle of the light ray; T_{Q} is a tangential vector of point Q; and angle β is an included angle between T_{Q} and a horizontal line. The coordinates of point T is the location where the light is to converge after being refracted. Point H is a vertical projection of point Q on the optic axis 10. In the drawing, the included angle between a refracted light ray and the horizontal axis changes with the location of point Q. In other words, the location of point Q must be determined first before the direction of a refracted light ray can be identified and the tangential vector T_{Q} of point Q can be calculated. Since the computation sequence of this process is inconsistent to the computation process of the exact solution process, this geometric problem can only be handled with the approximating process to determine the location of the control point.

According to the computation process of the approximating process, during the computation of each light ray, the coordinates of point Q are considered known parameters. For example, the coordinates of point Q for the first light ray are the coordinates of the initial point Q₀. The geometric relationship of FIG. 11 provides the following equation:

$$\begin{matrix}∠ TQH - {θ}_{4} + i + {θ}_{3} = π & ( 1.19 ) \\ β = i + {θ}_{3} - \frac{π}{2} & ( 1.20 )\end{matrix}$$

Since the coordinates of points T, Q, and H are known, the angle ∠TQH is defined as:

$$∠ TQH = {tan}^{- 1} ( \frac{\overline{TH}}{\overline{PH}} ) \qquad ( 1.21 )$$

Solving equations (1.14), (1.19), and (1.21) simultaneously provides the following solution:

$${θ}_{3} = {tan}^{- 1} ( \frac{sin a}{{n}_{3} - cos a} ) \\ where \\ a = π - i - {tan}^{- 1} ( \frac{\overline{HT}}{\overline{QT}} ) \qquad ( 1.22 )$$

which is a function of i. Thus, for each light ray of known angle i, “a” is a constant. Combining equation (1.22) with equation (1.20) provides the angle β as follows:

$$β = \frac{π}{2} - {tan}^{- 1} ( \frac{\overline{TH}}{\overline{QH}} ) + {tan}^{- 1} ( \frac{sin a}{{n}_{3} - cos a} ) \qquad ( 1.23 )$$

and the tangential vector T_{Q} of point Q is:

$${T}_{Q} = [ - 1 , tan ( \frac{π}{2} - {tan}^{- 1} ( \frac{\overline{TH}}{\overline{QH}} ) + {tan}^{- 1} ( \frac{sin a}{{n}_{3} - cos a} ) ) ] \qquad ( 1.24 )$$

With the calculation of the tangential vector for each point Q of the refraction surface properly done, the approximating process is applied for determination of the coordinates of all the control points, with which the desired freeform curve can be obtained, namely the refracting-converging surface 14 of the ellipsoid collimation lens 1.

Afterwards, the step of acquiring freeform surface control point is performed, in which either the approximating process or the exact solution process is adopted for computation of coordinates of control points required for construction of a freeform surface.

(A) Approximating Process

FIG. 12 shows the approximating process. The purpose of the present invention is to make a light ray emitting from a light source to travel in parallel to an optic axis 10 after being reflected. Under the assumption that the light source is an ideal light source and all the light rays from the light source must be re-directed to be parallel to the optic axis 10. In the drawing, the original point of light source is indicated by “O” and light rays from the light source are respectively indicated by i₀, i₁, i₂, i₃. Circular dots P₀, P₁, P₂, P₃ represent points where the incidence light rays impinge on an optic surface. Phantom lines T₀, T₁, T₂ respectively represent tangential vectors of points P₀, P₁, P₂. The location of the original point of light source O, the incidence light rays i₀, i₁, i₂, i₃, and the coordinates of initial point P₀ of the optic surface are known parameters, while coordinates of points P₁, P₂, P₃ (namely the coordinates of control points of the freeform surface to be acquired) and the tangential vectors T₀, T₁, T₂ are unknown parameters.

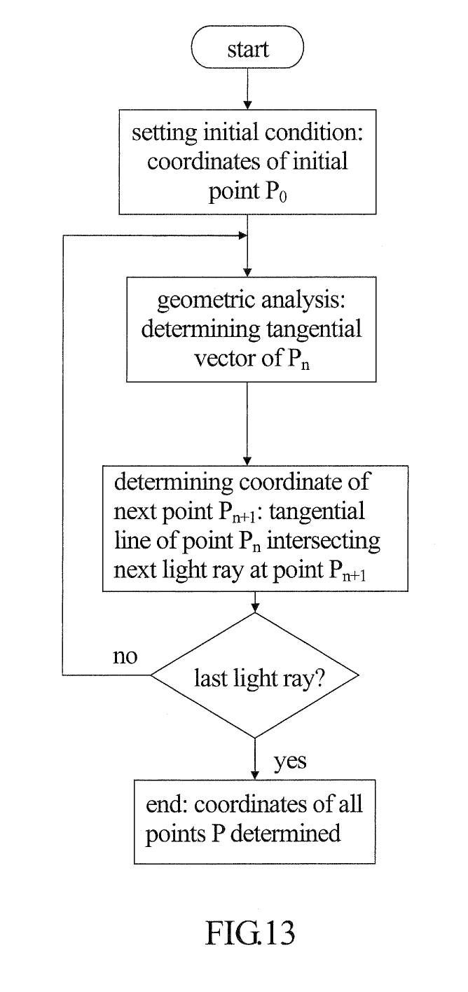

The computation of the coordinates of points P is carried out as illustrated in FIG. 13. Firstly, the light ray i₀ and the coordinates of the initial point P₀ are used to carry out geometric analysis for determination of tangential vector T₀. A straight line is drawn along tangential vector T₀ from point P₀ and the straight line intersects the next light ray i₁ at point P₁. To this point, the determination of the first light ray is done. The second light ray (as well as the following light rays) is determined in the same way as that of the first one, but with point P₁ being treated as new point P₀ and corresponding geometric analysis is taken for the associated light ray to determine the associated tangential vector, which is then made intersecting the following light ray to determine the intersection point. By repeating this process, the coordinates of all the P points can be determined. Further, in the process of FIG. 13, point P₀ serves as the initial point for the whole freeform surface or freeform curve and must be determined by a designer before the computation process is performed. The location of point P₀ will affect the volume of the whole optic structure designed.

The coordinates of all the points P obtained through the above process are used as control points of the freeform surface for subsequent operation of construction of three-dimensional model and for drawing of smooth curves passing through all the control points (with the aid of three-dimensional modeling software), which are the desired freeform curves. Geometric processing is then performed on the curves so drawn, such as translation, rotation, and Boolean operations, to complete the formation of the optic structure. The structure so designed can be supplied to optic simulation software for light ray tracking and analysis of simulation.

(B) Exact Solution Process

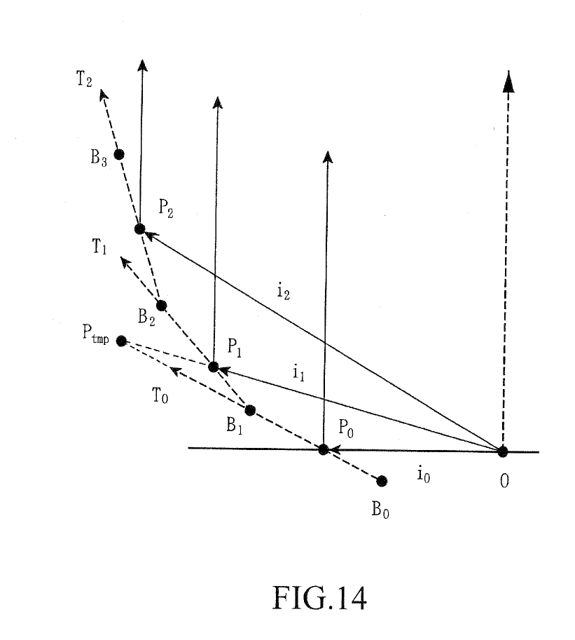

FIG. 14 shows a graphic illustration of the exact solution process. The present invention attempts to make a light ray emitting from a light source to travel in parallel to an optic axis 10 after being reflected. The system light source is assumed to be an ideal light source and all the light rays from the light source must be set to be parallel to the optic axis 10. In the drawing, the original point of light source is indicated by “O” and light rays from the light source are respectively indicated by i₀, i₁, i₂. Circular dots P₀, P₁, P₂ represent points where the incidence light rays impinge on an optic surface. Phantom lines T₀, T₁, T₂ respectively represent tangential vectors of point P₀, P₁, P₂. Circular dots B₀, B₁, B₂, B₃ are control points for constructing the freeform surface, and the point Pₜₘₚ is a temporary point used in the computation process. The location of the original point of light source O, the incidence light rays i₀, i₁, i₂, and the coordinates of initial point P₀ are known parameters, while coordinates of points P₁, P₂, the tangential vectors T₀, T₁, T₂, and the coordinates of the control points B₀, B₁, B₂, B₃ are unknown parameters and are to be determined by means of for example computer programs.

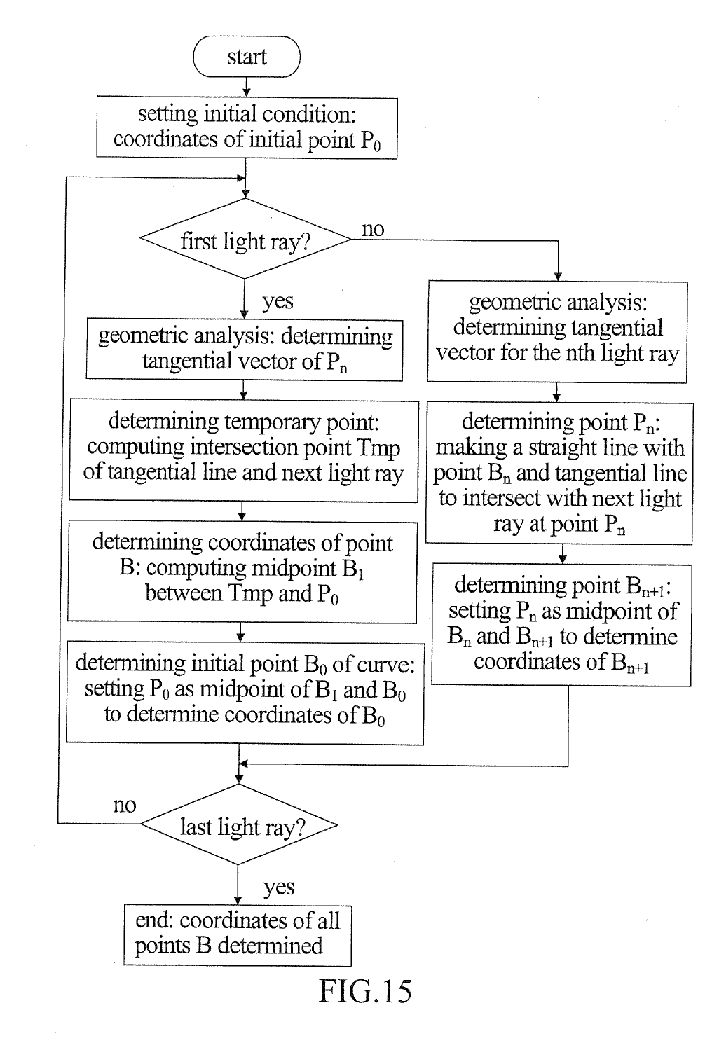

The operation of the exact solution process is illustrated in FIG. 15. Firstly, the light ray i₀ and the coordinates of the initial point P₀ are used to carry out geometric analysis for determination of tangential vector T₀. A straight line is drawn along tangential vector T₀ from point P₀ and the straight line intersects the next light ray i₁ at point Pₜₘₚ. A midpoint B₁ between P₀ and Pₜₘₚ is then determined. By setting point P₀ as the midpoint between point B₀ and point B₁, the coordinates of point B₀ can be determined. To this point, the determination of the first light ray is done. Then, the geometric analysis is carried out for the second ray i₁ to determine the tangential vector T₁ for the desired optic surface. A straight line is drawn along the tangential vector T₁ and passes through point B₁ so that the line intersects the light ray at point P₁. By setting point P₁ as the midpoint between point B₁ and point B₂, the coordinates of point B₂ can be determined. To this point, the determination of the second light ray is done. The third light ray, as well as the following light rays, can be determined in the same way as that of the second one, but with point B₂ being treated as point B₁ of the second light ray and the determination process of the second light ray is repeated to thereby determine the coordinates of all the B points. The determination process is illustrated in FIG. 15, wherein point P₀ serves as the initial point for the whole freeform surface and must be determined by a designer before the computation process is performed. The location of point P₀ will affect the volume of the whole optic structure designed. The purpose of the process is to determine all B points to serve as control points of the freeform surface.

The coordinates of all the points B obtained through the above process are used as control points of the freeform surface for subsequent operation of construction of three-dimensional model and for drawing of smooth curves passing through all the control points, which are the desired freeform curves. Geometric processing is then performed on the curves so drawn, such as translation, rotation, and Boolean operations, to complete the formation of the optic structure.

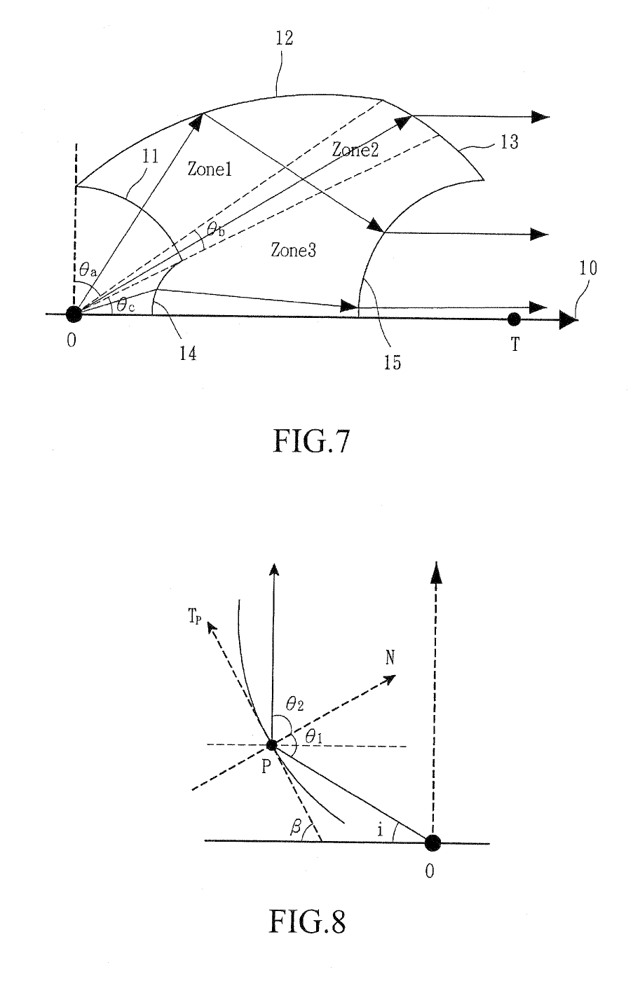

Then, the step of constructing a three-dimensional model is performed. The design method of the present invention uses the light source that is identified in the step of identifying optic field pattern of light source as an input parameter and uses the optic field pattern to be presented on the receiving surface as an output parameter and followed by applying the step of performing graphic analysis of freeform surface tangential vector formula and the step of acquiring freeform surface control points to determine the coordinates of points of the whole freeform surface, and then supplies the coordinates of the points so determined to three-dimensional modeling software to construct two-dimensional freeform curves, such as the two-dimensional contour of the ellipsoid collimation lens 1 shown in FIG. 7 according to the present invention, in which the solid lines define the contour of the lens, the left side circular dot on the optic axis 10 is the location of the light source, and the right side circular dot on the optic axis 10 is a destination convergence point where light converges after being reflected or refracted. The two-dimensional drawing of the collimation lens 1 is divided into three zones, respectively defined as Zone1, Zone2, and Zone3, which will be discussed. In Zone1, light distribution is within an angular range of θₐ and the light travels through the spherical surface 11 to directly enter the lens. The light is then re-directed by the circumferential reflection surface 12 to travel in a direction toward the convergence point T. Before the light converges, it passes through the converging-refracting-parallel surface 15 by which the light is re-directed to travel in parallel to the optic axis 10 for outwards emission. In Zone2, light distribution is within an angular range of θ_{b} and the light travels through the spherical surface 11 to directly enter the lens and then impinges on the refracting-parallel surface 13 by which the light is re-directed to travel in parallel to the optic axis 10 for outward emission from the lens. In Zone3, light distribution is within an angular range of θ_{c} and the light first impinges on the refracting-converging surface 14 to be re-directed to travel in a direction toward the convergence point T. Before the light converges, it passes through the converging-refracting-parallel surface 15 by which the light is re-directed to travel in parallel to the optic axis 10 for outwards emission from the lens. In an example of the present invention, the ratio among the angular ranges of the three zones is, approximately, θₐ:θ_{b}:θ_{c}=56°:10°:24°.

The design of collimation lens 1 according to the present invention comprises five major optic surfaces, which are respectively the spherical surface 11, the reflection surface 12, the refracting-parallel surface 13, the refracting-converging surface 14, and the converging-refracting-parallel surface 15. Except the spherical surface 11, all the remaining four optic surfaces are freeform surfaces obtained through application of either an exact solution process or an approximating process. Among the five optic surfaces, the one that must be design first is the reflection surface 12, for the aperture of the whole collimation lens 1 must be determined first. And the next one to be determined is the spherical surface 11. According to the present invention, the radius of the spherical surface 11 is exactly identical to the shortest distance between the reflection surface 12 and the light source. The third one to be determined in the refracting-converging surface 14, this optic surface possessing a starting point set on the optic axis 10. The distance between the starting point and the light source is not allowed to get greater than the radius of the spherical surface 11, but it cannot be set too close to the light source for this deteriorates the collimation performance. The fourth one to be determined is the converging-refracting-parallel surface 15. The design criteria for this optic surface are two, of which the first one is the optic surface must be made as large as possible to enhance the collimation performance and the second is the range of the optic surface may not extend to Zone2; otherwise light of Zone2 impinging on this optic surface would lead to total reflection, which in turn makes the collimation performance poor. The final one to be determined is the refracting-parallel surface 13. Once the determination process for converging-refracting-parallel surface 15 is completed, the last point of the curve can be treated as a starting point for refracting-parallel surface 13 to start the determination process for the refracting-parallel surface 13.

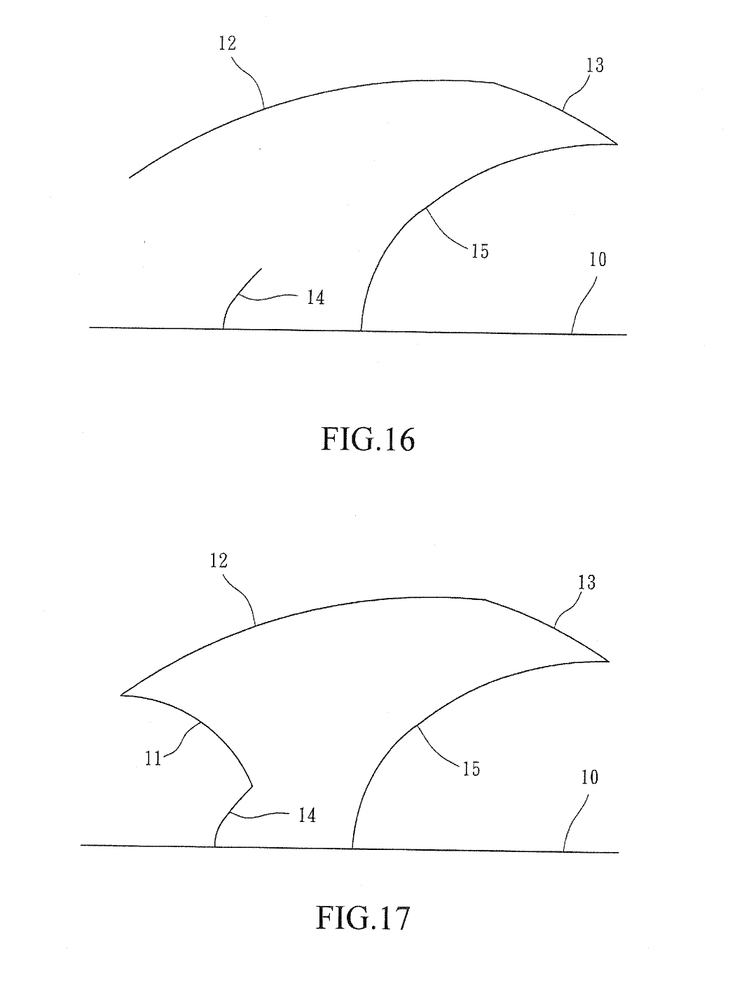

A proposed process for constructing the ellipsoid collimation lens 1 is to first draw the freeform curves. FIG. 16 shows an example wherein geometric construction software is applied to draw four freeform curves of the ellipsoid collimation lens 1 according to the present invention. Since the present invention adopts a rotational symmetric design, it is only needed to determine the freeform surface on a three-dimensional drawing. The lines shown in the drawing of FIG. 16 are respectively the optic axis 10 and four freeform curves (compared to FIG. 7), which are respectively the reflection surface 12, the refracting-converging surface 14, the converging-refracting-parallel surface 15, and the refracting-parallel surface 13, when counted from the left side to the right side. Then, the missing portion must be supplemented. For example, as shown in FIG. 17, besides the four freeform curves, a circular arc is additionally drawn.

Finally, the step of performing geometric processing is carried out to complete all the two-dimensional curves and to make a rotation of 360 degrees about the optic axis 10 by which the structure of the collimation lens 1 is done. FIG. 6 shows a two-dimensional drawing of the collimation lens 1 after the rotation. FIG. 5 shows a three-dimensional form of the ellipsoid collimation lens 1 according to the present invention.

With the above discussed structure and design of freeform surfaces, the present invention provides a collimation lens 1, which is subjected to optic simulation by using an ideal light source to inspect the collimation performance of the collimation lens 1. The result indicates that the collimation lens 1 meets the requirements of design. An LED chip is used as a light source for practical test of the collimation lens 1, in which light is projected by the collimation lens 1 to a circular inspection surface that is located at a distance of 200 meters and has a diameter of 35 meters. The opening angle between the light source and the inspection surface is around ±5°. Under this condition, it is appreciated that the collimation lens 1 makes an optic collimation performance of approximately 88%. Other modeling parameters, including light emission area, aperture, location of light source, are also tested for their influences on the collimation performance of the lens. Finally, a plot of the collimation performance of the lens is used to estimate the maximum projection distance of the collimation lens 1. Since the optic structure is determined through a computation process, it only needs to make the light source satisfying the desired characteristics in the optic simulation operation, and then the optic field pattern formed by the light traveling through the optic structure must correspond to what is desired for the design. This greatly enhances the precision and reliability of design.

The collimation lens 1 according to the present invention is applicable to LED based light sources and it overcomes the drawback of the conventional collimation lenses that are formed by assembling multiple lenses together, which leads to waste of space and poor collimation performance. Further, the collimation lens 1 according to the present invention possesses freeform surfaces and is integrally formed as a unitary member. The troublesome operation of properly positioning lenses can be eliminated and the amount of space and the length can be reduced. Therefore, the practicability and performance of the collimation lens 1 are enhanced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A freeform surface included lens design method, which is applied to design a structure of optic lens arranged between an optic field pattern of light source having known parameters and a desired optic field pattern of a receiving surface, the method comprising a step of identifying the optic field pattern of light source, a step of performing graphic analysis of freeform surface tangential vector formula, a step of acquiring freeform surface control point, a step of constructing a three-dimensional model, and a step of performing geometric processing, wherein:
the step of identifying the optic field pattern of light source is performed in such a way that modeling parameters, including luminous intensity distribution, light emission area, aperture, and location, of the light source are identified and further, modeling parameters of the desired optic field pattern, including maximum projection brightness, projection illumination, projection distance, and projection area of light projected from the light source, are determined for the receiving surface;
the step of performing graphic analysis of freeform surface tangential vector formula is carried out for handling geometric problems during the design of the lens;
the step of acquiring freeform surface control point is performed in such a way that one of approximating process and exact solution process is adopted for computation of coordinates of control points required for construction of a freeform surface;
the step of constructing a three-dimensional model is performed in such a way that the light source that is identified in the step of identifying optic field pattern of light source is used as an input parameter and the desired optic field pattern of the receiving surface that is identified in the step of identifying optic field pattern of light source is used as an output parameter and further applying the step of performing graphic analysis of freeform surface tangential vector formula and the step of acquiring freeform surface control points to determine the coordinates of points of the whole freeform surface, and then supplies the coordinates of the points so determined to three-dimensional modeling software to construct two-dimensional freeform curves; and
the step of performing geometric processing is carried out in such a way to complete all two-dimensional curves and to make a rotation of 360 degrees about an optic axis by which the structure of the collimation lens is done.

2. The method according to claim 1, wherein the approximating process of the step of acquiring freeform surface control point is performed after the step of identifying the optic field pattern of light source by providing an original point of light source O, light rays from the light source being indicated by i₀, i₁, i₂, i₃, circular dots P₀, P₁, P₂, P₃ representing points where incidence light rays impinge on the optic surface, phantom lines T₀, T₁, T₂ respectively representing tangential vectors of points P₀, P₁, P₂, wherein location of the original point of light source O, the incidence light rays i₀, i₁, i₂, i₃, and coordinates of initial point P₀ of the optic surface are known parameters, and coordinates of points P₁, P₂, P₃ and the tangential vectors T₀, T₁, T₂ are unknown parameters, and wherein computation of the coordinates of points P is carried out in such a way that firstly, the light ray i₀ and the coordinates of the initial point P₀ are used to carry out geometric analysis for determination of tangential vector T₀, a straight line being drawn along tangential vector T₀ from point P₀, the straight line intersecting a next light ray at point P₁, this completing computation of the first light ray; wherein the second light ray, as well as the following light rays, is determined in the same way as that of the first one, but with point P₁ being treated as new point P₀ and corresponding geometric analysis is taken for the associated light ray to determine the associated tangential vector, which is then made intersecting the following light ray to determine the intersection point, this process being repeated to determine the coordinates of all P points, the coordinates of all points P being used as control points of the freeform surface.

3. The method according to claim 1, wherein the exact solution process of the step of acquiring freeform surface control point is performed after the step of identifying the optic field pattern of light source by providing an original point of light source O, light rays from the light source being respectively indicated by i₀, i₁, i₂, circular dots P₀, P₁, P₂ representing points where the incidence light rays impinge on the optic surface, phantom lines T₀, T₁, T₂ respectively representing tangential vectors of point P₀, P₁, P₂, circular dots B₀, B₁, B₂, B₃ being control points for constructing the freeform surface, and a point Pₜₘₚ being a temporary point used in the computation process, wherein the location of the original point of light source O, the incidence light rays i₀, i₁, i₂, and the coordinates of initial point P₀ are known parameters, and coordinates of points P₁, P₂, the tangential vectors T₀, T₁, T₂, and the coordinates of the control points B₀, B₁, B₂, B₃ are unknown parameters and are to be determined by means of computer programs, wherein computation of the exact solution process is carried out in such a way that firstly, the light ray i₀ and the coordinates of the initial point P₀ are used to carry out geometric analysis for determination of tangential vector T₀, a straight line being drawn along tangential vector T₀ from point P₀, the straight line intersecting a next light ray i₁ at point Pₜₘₚ, a midpoint B₁ between P₀ and Pₜₘₚ being then determined, setting point P₀ as a midpoint between point B₀ and point B₁ to determine coordinates of point B₀, this completing the determination of the first light ray; afterwards, geometric analysis is carried out for the second ray i₁ to determine the tangential vector T₁ for the desired optic surface, a straight line being drawn along the tangential vector T₁ and passing through point B₁ so that the line intersects the light ray i₁ at point P₁, setting point P₁ as a midpoint between point B₁ and point B₂ to determine the coordinates of point B₂, this completing the determination of the second light ray; and wherein the third light ray, as well as the following light rays, is determined in the same way as that of the second one, but with point B₂ being treated as point B₁ of the second light ray and the determination process of the second light ray is repeated to thereby determine the coordinates of all the B points, this process determining the coordinates of all the B points, which are used as control points of the freeform surface.

4. A freeform surface included collimation lens design method, which is a method for designing an ellipsoid collimation lens, the method comprising a step of identifying the optic field pattern of light source, a step of performing graphic analysis of freeform surface tangential vector formula, a step of acquiring freeform surface control point, a step of constructing a three-dimensional model, and a step of performing geometric processing, wherein:
the step of identifying the optic field pattern of light source is performed in such a way that modeling parameters, including luminous intensity distribution, light emission area, aperture, and location, of the light source are identified and further, modeling parameters of the desired optic field pattern, including maximum projection brightness, projection illumination, projection distance, and projection area of light projected from the light source, are determined for the receiving surface;
the step of performing graphic analysis of freeform surface tangential vector formula is carried out during the design of the collimation lens to handle geometric problems of (A) the spot light source being reflected by a freeform surface to converge at a point; (B) the spot light source beings refracted by a freeform surface to travel in parallel to an optic axis for outward emission; and (C) the spot light source being refracted by a freeform surface to converge at a point;
the step of acquiring freeform surface control point is performed in such a way that one of approximating process and exact solution process is adopted for computation of coordinates of control points required for construction of a freeform surface;
the step of constructing a three-dimensional model is performed in such a way that the light source that is identified in the step of identifying optic field pattern of light source is used as an input parameter and the desired optic field pattern of the receiving surface that is identified in the step of identifying optic field pattern of light source is used as an output parameter and further applying the step of performing graphic analysis of freeform surface tangential vector formula and the step of acquiring freeform surface control points to determine the coordinates of points of the whole freeform surface, and then supplies the coordinates of the points so determined to three-dimensional modeling software to construct two-dimensional freeform curves; and
the step of performing geometric processing is carried out in such a way to complete all two-dimensional curves and to make a rotation of 360 degrees about an optic axis by which the structure of the collimation lens is done.

5. The method according to claim 4, wherein the approximating process of the step of acquiring freeform surface control point is performed after the step of identifying the optic field pattern of light source by providing an original point of light source O, light rays from the light source being indicated by i₀, i₁, i₂, i₃, circular dots P₀, P₁, P₂, P₃ representing points where incidence light rays impinge on the optic surface, phantom lines T₀, T₁, T₂ respectively representing tangential vectors of points P₀, P₁, P₂, wherein location of the original point of light source O, the incidence light rays i₀, i₁, i₂, i₃, and coordinates of initial point P₀ of the optic surface are known parameters, and coordinates of points P₁, P₂, P₃ and the tangential vectors T₀, T₁, T₂ are unknown parameters, and wherein computation of the coordinates of points P is carried out in such a way that firstly, the light ray i₀ and the coordinates of the initial point P₀ are used to carry out geometric analysis for determination of tangential vector T₀, a straight line being drawn along tangential vector T₀ from point P₀, the straight line intersecting a next light ray i₁ at point P₁, this completing computation of the first light ray;
wherein the second light ray, as well as the following light rays, is determined in the same way as that of the first one, but with point P₁ being treated as new point P₀ and corresponding geometric analysis is taken for the associated light ray to determine the associated tangential vector, which is then made intersecting the following light ray to determine the intersection point, this process being repeated to determine the coordinates of all P points, the coordinates of all points P being used as control points of the freeform surface.

6. The method according to claim 4, wherein the exact solution process of the step of acquiring freeform surface control point is performed after the step of identifying the optic field pattern of light source by providing an original point of light source O, light rays from the light source being respectively indicated by i₀, i₁, i₂, circular dots P₀, P₁, P₂ representing points where the incidence light rays impinge on the optic surface, phantom lines T₀, T₁, T₂ respectively representing tangential vectors of point P₀, P₁, P₂, circular dots B₀, B₁, B₂, B₃ being control points for constructing the freeform surface, and a point Pₜₘₚ being a temporary point used in the computation process, wherein the location of the original point of light source O, the incidence light rays i₀, i₁, i₂, and the coordinates of initial point P₀ are known parameters, and coordinates of points P₁, P₂, the tangential vectors T₀, T₁, T₂, and the coordinates of the control points B₀, B₁, B₂, B₃ are unknown parameters and are to be determined by means of computer programs, wherein computation of the exact solution process is carried out in such a way that firstly, the light ray i₀ and the coordinates of the initial point P₀ are used to carry out geometric analysis for determination of tangential vector T₀, a straight line being drawn along tangential vector T₀ from point P₀, the straight line intersecting a next light ray i₁ at point Pₜₘₚ, a midpoint B₁ between P₀ and Pₜₘₚ being then determined, setting point P₀ as a midpoint between point B₀ and point B₁ to determine coordinates of point B₀, this completing the determination of the first light ray; afterwards, geometric analysis is carried out for the second ray i₁ to determine the tangential vector T₁ for the desired optic surface, a straight line being drawn along the tangential vector T₁ and passing through point B₁ so that the line intersects the light ray i₁ at point P₁, setting point P₁ as a midpoint between point B₁ and point B₂ to determine the coordinates of point B₂, this completing the determination of the second light ray; and wherein the third light ray, as well as the following light rays, is determined in the same way as that of the second one, but with point B₂ being treated as point B₁ of the second light ray and the determination process of the second light ray is repeated to thereby determine the coordinates of all the B points, this process determining the coordinates of all the B points, which are used as control points of the freeform surface.

7. A freeform surface included collimation lens, which comprises an integrally-formed unitary ellipsoid structure, the collimation lens comprising five interconnecting optic surfaces on each side of an optic axis, the optic surfaces including a spherical surface, a reflection surface, a refracting-parallel surface, a refracting-converging surface, and a converging-refracting-parallel surface, wherein except the spherical surface, all the remaining four surfaces are freeform surfaces obtained through a freeform surface design process;
the spherical surface being a concave spherical surface, functioning to allow light from a light source to directly enter the collimation lens without undesired deflection;
the reflection surface being a freeform surface obtained through an approximating process and functioning to re-direct light from the light source to converge in a direction toward a converging point, position of a starting point of the reflection surface determining aperture of the collimation lens, an end of the surface intersecting the spherical surface on a vertical axis of the light source;
the refracting-parallel surface being a freeform surface that is obtained through an exact solution process, light distribution of the collimation lens being divided into three zones due to a minor portion of the light from the light source not reaching the converging-refracting-parallel surface after being re-directed by the reflection surface, so that a portion of the reflection surface is modified to form the refracting-parallel surface, which is connected to an end of the reflection surface opposite to the spherical surface, whereby light impinging on the refracting-parallel surface is refracted to a direction parallel to the optic axis for exiting the collimation lens;
the refracting-converging surface being a freeform surface that is obtained through an approximating process and functioning for refracting a portion of light from the light source that is close to the optic axis to converge in a direction toward the converging point, the refracting-converging surface being connected to an end of the spherical surface that is opposite to the reflection surface; and
the converging-refracting-parallel surface being a freeform surface obtained through an exact solution process and functioning to refract the portion of light that is subjected to reflection and/or refraction by the reflection surface and/or the refracting-converging surface at the time when the portion of the light reaches the converging-refracting-parallel surface so that the light travel parallel to the optic axis for exiting the collimation lens;
whereby a freeform surface included collimation lens showing high collimation performance and having an integrally-formed unitary ellipsoid structure is provided.

8. The freeform surface included collimation lens according to claim 7, wherein the reflection surface comprises an outside face on which a mirror surface is formed to improve the reflectivity.
